(19) United States
(12) Patent Application Publication
(10) Pub. No.: US 2003/0216933 A1
(43) Pub. Date: Nov. 20, 2003

(54) Billing method and system for collaboration solutions

(76) Inventor: Edmund M. Kwan, Cupertino, CA (US)

Correspondence Address: Edmund M. Kwan, 10397 Las Ondas Way, Cupertino, CA, 95014, US

(21) Appl. No.: 10/400,312

(22) Filed: Mar. 27, 2003

Related U.S. Application Data
(63) Continuation-in-part of application No. 10/354,494, filed on Jan. 30, 2003.
Application No. 10/354,494 is a continuation-in-part of application No. 10/071,768, filed on Feb. 7, 2002.

(51) Int. Cl. G06F 17/60

(52) U.S. Cl. 705/1

(57) ABSTRACT

Methods and systems for service providers to provide hosted enterprise solutions to businesses, allowing these businesses to collaborate with other business partners or clients, via the Internet. Under such systems and methods, service providers would allow clients to decide which partners to invite to enroll in subscription plan in order to share and minimize the cost to the clients without having the clients incur a cumbersome approval process from all their partners.

### CROSS-REFERENCES TO RELATED APPLICATIONS

The present invention is a continuation-in-part of U.S. patent application Ser. No. 10/354,494, filed on Jan. 30, 2003, and entitled “Billing Method and System for Collaboration Solutions, which is a continuation-in-part of U.S. patent application Ser. No. 10/071,768, filed on Feb. 7, 2002, and entitled “Billing Method and System for Collaboration Solutions,” both of which are incorporated herein in their entirety for all purposes, and both of which this application claims priority to.

### DESCRIPTION

The present invention generally relates to the costing and billing methods of service providers to their Clients, who use collaboration enterprise applications via the Internet hosted by service providers and, more particularly, a cost-sharing system provided by the providers to the clients to manage billing activities among their collaboration communities.

The following lists the meanings of some terms as used herein:

Partner: A business, an individual or a group with whom Clients use the enterprise solution to collaborate.

Service Provider: A company, which provides enterprise solutions or enterprise solutions accounts to individuals, businesses, and other groups.

Client: A business, an individual and a group that has been committed to use hosted enterprise solutions provided by the service provider.

Collaboration community—A client and all of its collaboration partners.

Subscriber: A partner who purchased a subscription with the service provider.

Invitee—A partner who will be invited to become a subscriber.

Enterprise solution: A software solution that improve productivities, which can be used by more than one person.

Online solution: An enterprise application that runs and executes on the Internet.

Billing solution—an enterprise solution available online, provided by the service providers to the Clients, that allows the clients to administrate the cost-sharing program within their collaboration communities.

External revenue—total revenue of a particular collaboration community to the service providers, excluding client's contribution.

### BACKGROUND OF THE INVENTION

Whereas clients are often responsible for the cost when they are committed to use enterprise solutions hosted by service providers to collaborate with their partners via the Internet, their partners are often not. Since the partners get to use the solutions paid for by the Clients, although sometimes with relatively limited functions, they now have little incentive to subscribe to such enterprise solutions from the service providers.

Thus, the client is often the only paying party in his collaboration community. This is not a fair model. In the long run, clients would harbor resentment for being the only payee in the collaborating community, resulting in potential loss of business for the service providers.

There are also those solutions hosted by service providers that require all participants within the collaboration community to pay subscription fees based on an open formula, which treats all participants equally. A Client, who chooses these solutions, may invite others to join. In this model, clients typically obtain approvals from all participants. This is a very cumbersome process. Until every partner reaches an agreement, collaboration solutions cannot begin to execute.

There are also those solutions hosted by service providers that require all participants within the collaboration community to pay subscription fees, according to different formulas. They nonetheless still require a complex approval process.

### SUMMARY OF THE INVENTION

Clients would be better served if there were ways for them to share the enterprise solutions cost with their collaborating partners and that require only simple procedures for approval and consent.

A cost-sharing system and method for the clients is provided, allowing them to adapt enterprise solutions hosted by the service providers, and to share such solutions costs with partners with whom the clients feel are willing to share costs, while also collaborating with those who will not.

Cost-sharing systems are provided by the service providers to the clients, allowing the clients to improve the management of cost-sharing administration of their collaboration communities.

Systems and methods according to some embodiments of the present invention also allow the service providers to reward the clients for their efforts in organizing and starting their collaboration communities, such that the entire subscription fees of the clients may be waived.

Traditionally, clients would make financial commitments to the service providers for the privilege of using any types of enterprise solutions to collaborate with their partners via the Internet. In one embodiment according to the present invention, the clients would now have, in addition to the above, the rights to invite his partners to sign up with the service provider directly. The clients will be given the flexibility to decide which partners to invite. Traditionally, clients are not given the flexibility of creating an invitee list.

Thus, the more subscribers the clients can generate, the less the financial obligation they have to the service providers. Potentially, the clients may be able to pass the entire cost of subscriptions to all of the subscribers, provided that the'amount of external revenue, which is pre-determined by the service providers, has been reached. Pre-determined figures can be changed from time to time, as desired by the service providers.

To manage the dynamic membership status of partners, invitees and subscribers within a certain collaboration community, the service providers would provide cost-sharing management systems to the clients to allow them to manage and administrate the cost-sharing programs. Clients can use this management tool to manage the process of cost-sharing and be able to control and monitor their own subscription fees periodically.

The cost-sharing management system would allow the Clients to send electronic messages to all the invitees within the clients' collaboration communities, inviting them to become subscribers. If the invitees were interested, they would be able to enroll subscription online at the service providers' enrollment web sites. If the invitees do not wish to enroll via the service providers' web site, they could contact the service providers to arrange for other means of enrollment.

Once the service providers accepted the invitees' applications for subscriptions, the invitees have become subscribers. The service providers would update the system, thus acknowledging the clients that their invitees are now subscribers. If the invitees decided not to become subscribers, they would also notify the service providers at enrollment web site. Service Providers will update the systems and allow access by their clients.

Clients are only given authorized access on their own unique collaboration communities.

Service providers would maintain a listing of unresponsive invitees, which can be accessed by the clients; the clients can send additional messages to urge the unresponsive invitees to make a decision. This process will continue, if desired by the clients, until hopefully all the invitees have come to a decision.

The clients now begin a mature and a routine phase of subscription management.

### BRIEF DESCRIPTION OF THE DRAWINGS

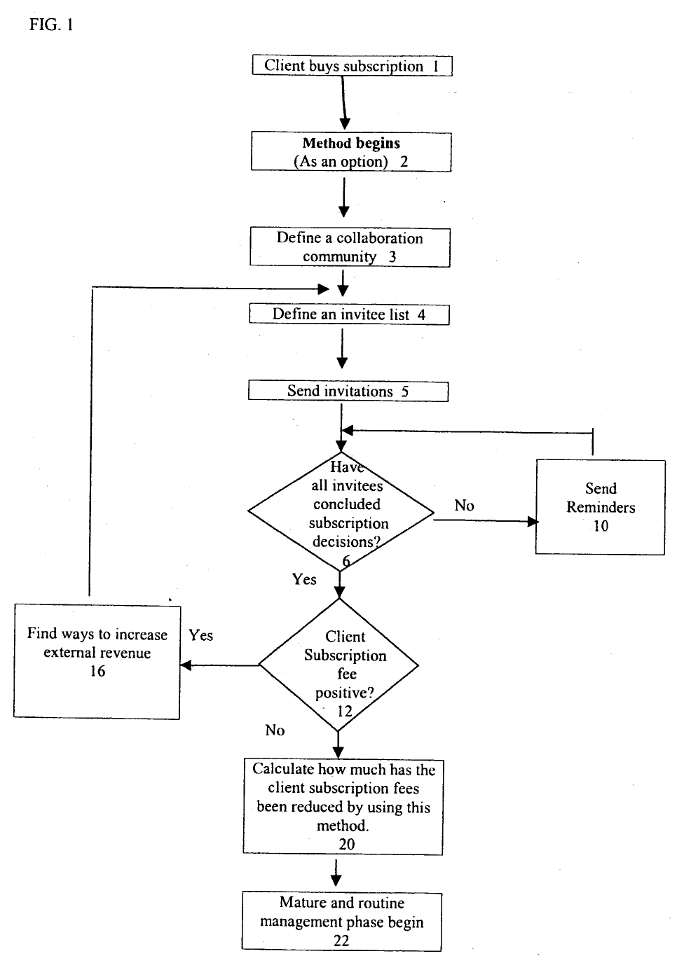

In FIG. 1, a flow chart elucidating one embodiment according to the present invention.

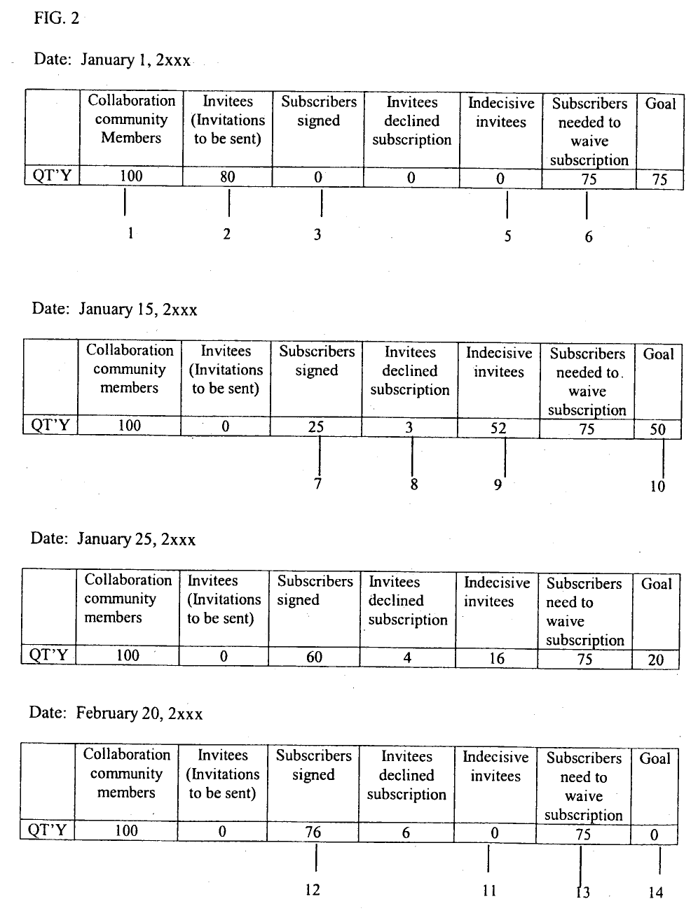

In FIG. 2, a system of cost-sharing solution is depicted, allowing the client to manage, for example, the number of subscribers against the goal set forth by the service providers.

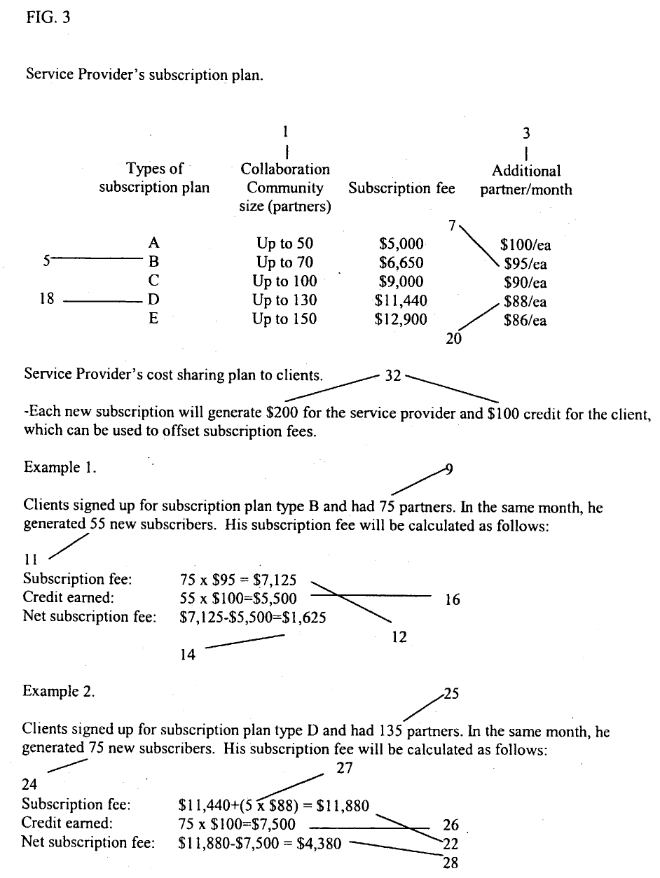

In FIG. 3, a system of cost-sharing solution facilitating the usage of subscriber revenue, as an example, to earn credits for the client.

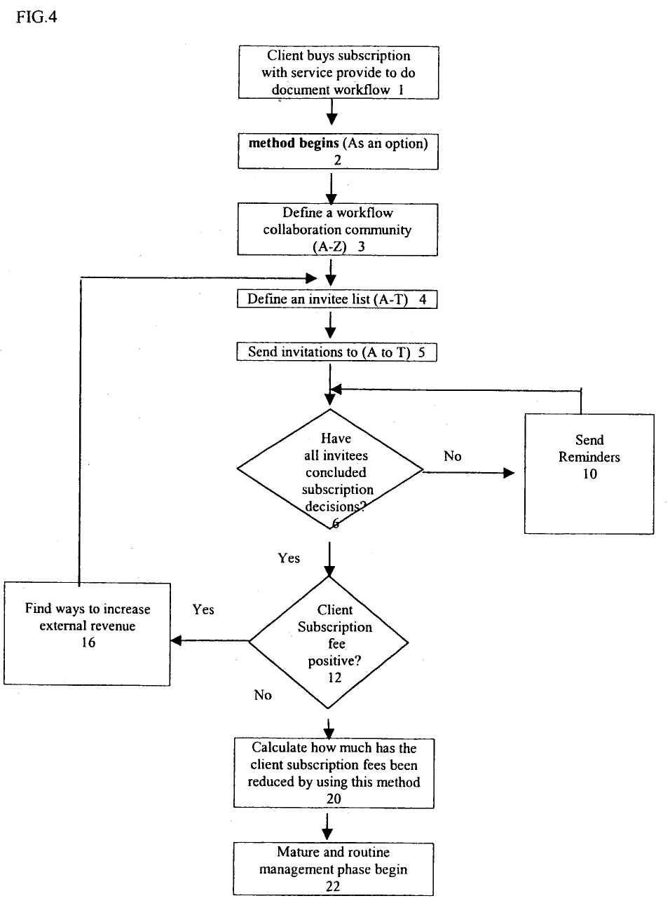

In FIG. 4, applying this method to a document workflow enterprise solution, as an example.

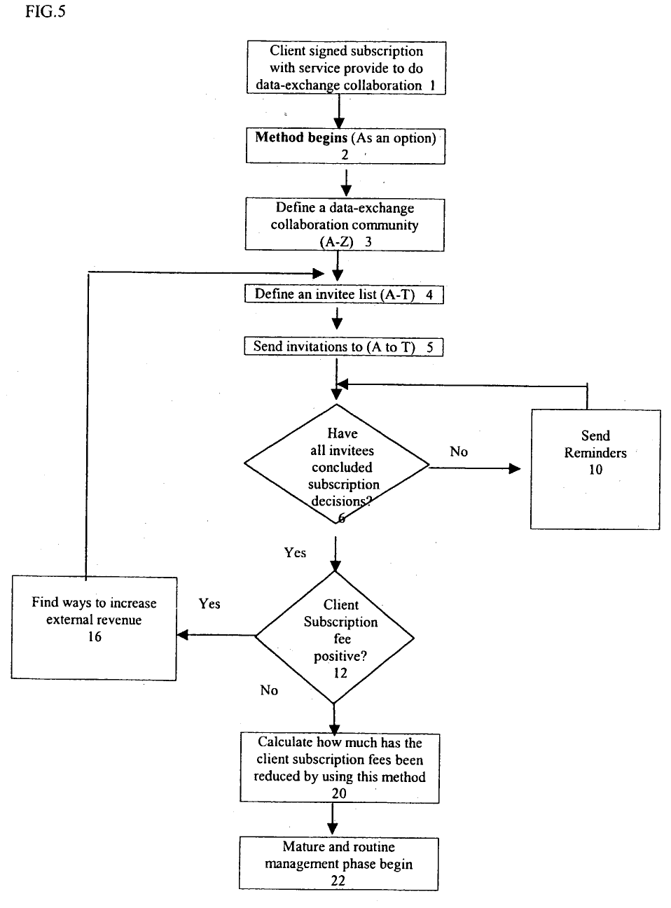

In FIG. 5, applying this method to a data-exchange extended enterprise solution, as an example.

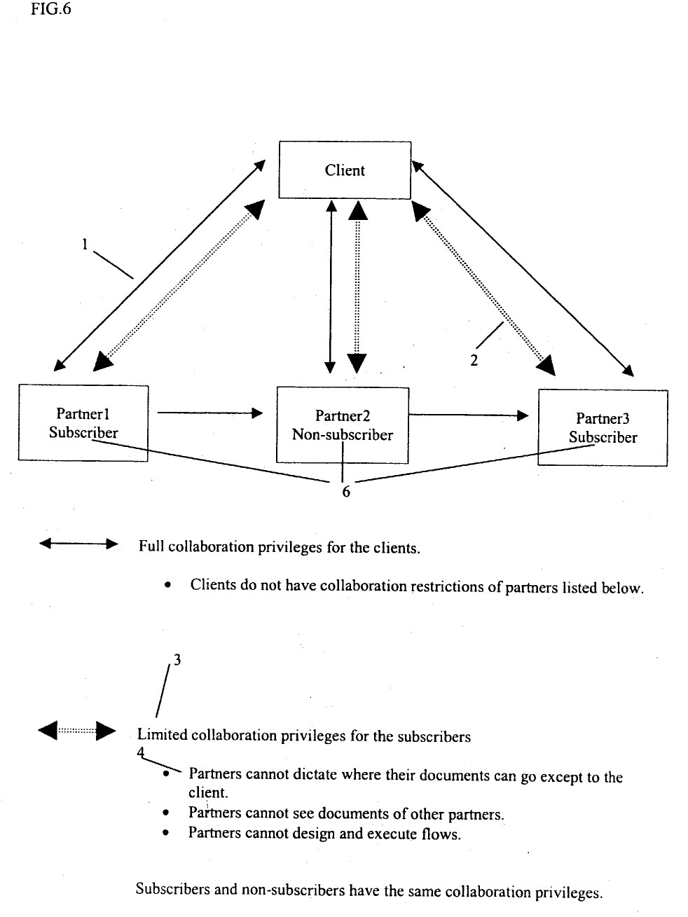

In FIG. 6, this diagram, using workflow as an example, illustrates collaboration privileges assigned to subscribers and clients that could, for example, be different.

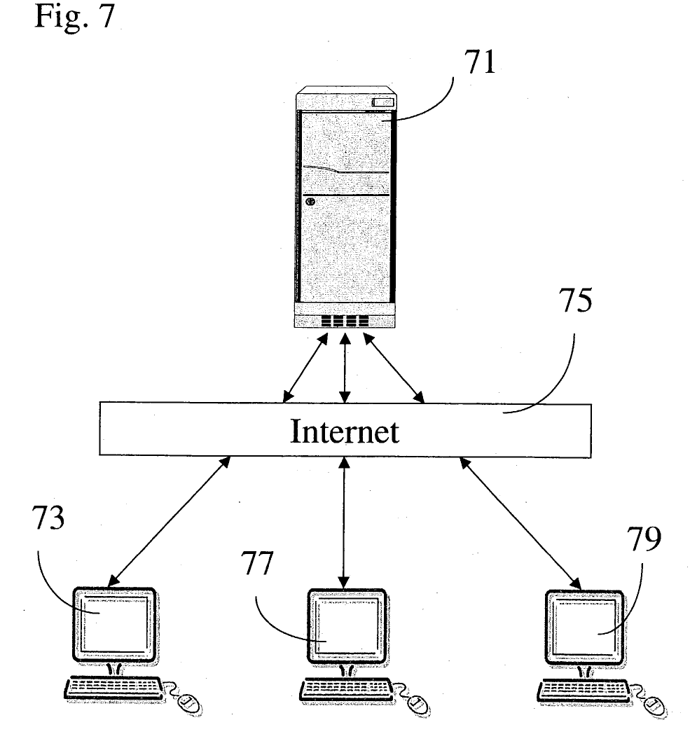

In FIG. 7, this diagram illustrates, as an example, different modules working in conjunction with the hosted enterprise solution.

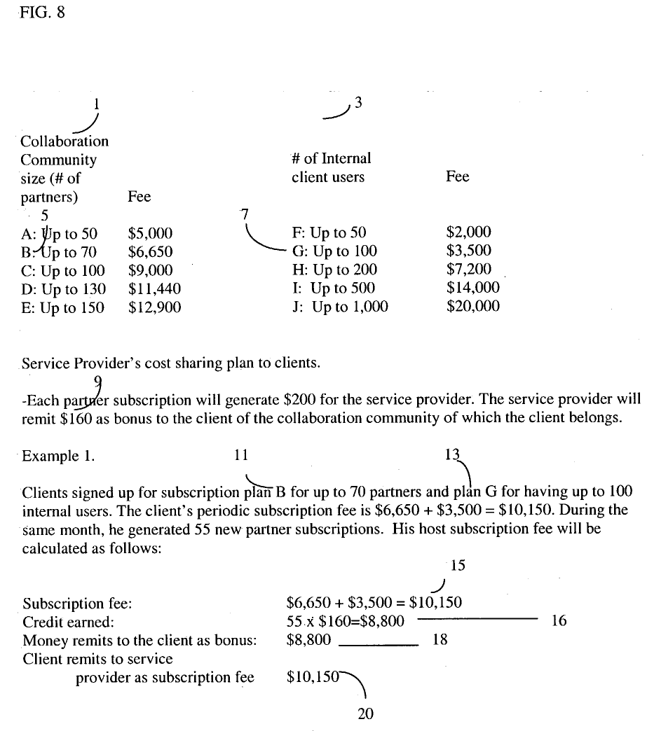

In FIG. 8, a system of cost-sharing solution illustrating, as an example, the client earning money from partners' subscription revenue in its collaboration community.

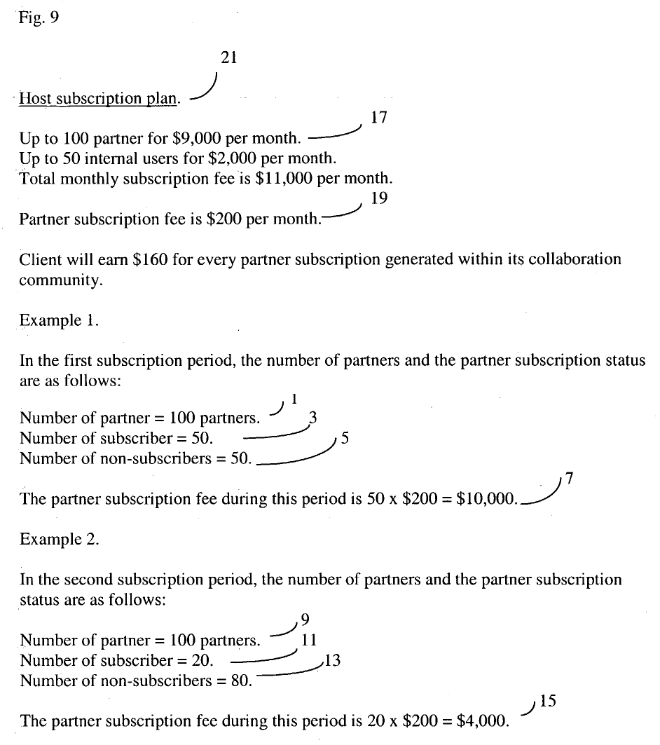

In FIG. 9, an example showing calculation of partner subscription fees in two different subscription periods.

### DETAILED DESCRIPTION

Referring to FIG. 1, at step 1, client buys a subscription with the service provider for usage of an enterprise solution for collaboration purposes. The enterprise solution could be developed in-house by the service provider, by an external 3^{rd} party or jointly developed by both service provider and the external 3^{rd} party.

Typically, the subscription procedures end here.

At step 2, the client can use this method, as an option, to reduce his subscription fee.

At step 3, the client begins by defining all the partners with whom he wishes to collaborate, known as a collaboration community.

At step 4, the client would create a list within the collaboration community, known as an invitee list, by using the billing solution facilitated by the service provider. An invitee is a partner the client feels would be willing to buy a subscription.

When a partner is not included in the invitee list, this may imply that the client could be intending to either pay, or to generate more external revenue elsewhere to earn credit to cover the enterprise solution fees for this partner's usage.

An invitee list will change from time to time since clients' assessment of each invitee changes from time to time.

At step 5, the solution would also facilitate mail merge, merging invitees with invitation templates to generate invitations, inviting invitees to buy subscriptions directly with the service provider.

At step 6, the client would use the billing system to monitor the number of indecisive invitees. If he feels that they should be reminded, he will proceed to generating more reminders via the billing system 10. The number of undecided invitees should become less as more invitees come to the subscription conclusion.

The reminder generation process would be repeated until hopefully all the invitees have concluded the subscription decisions.

There are times although the number of inconclusive invitees is still positive, the client may decide not to generate any reminders. Step 10 and step 12 can be executed in parallel.

At step 10, client would generate reminders via the client billing system from time to time to urge the indecisive invitees to quickly conclude the subscription decisions.

At step 12, until subscription fee reaches zero, the client should continue to find ways to increase external revenue. Please be advised that the client does not have to wait until his subscription fee has been reduced to zero before proceeding to step 20. Step 20 and 16 can be executed in parallel.

At step 16, the client would want to earn more credit by further increase external revenue, thus generating more credit to offset the subscription fee. External revenue could include but not limited to revenue of subscribers' subscription fees, revenue of subscribers' users subscription fees and revenue on collaboration data volume.

At step 20, at any time, the client is in a position to calculate how much credit he earned with the external revenue he generated. He can now see how much the subscription fee is reduced by using this method.

At step 22, the client now enters a more mature and routine management phase of managing the cost-sharing program.

Without this method, the client would either typically pay for the solution, thus being the only payee in the collaboration community, or he would have to obtain other partners' agreement to buy subscription before collaboration can begin to execute, thus going thru a cumbersome process.

This flow chart illustrated that this method makes it possible for the service providers to reward clients for their efforts in building a collaboration community and ability to generate external revenue for the service provider.

Referring to FIG. 2, at label 1, on Jan. 1, 2xxx, a client had just signed up for a subscription plan of 100 partners. The service provider would offer a billing solution to this client, thus allowing this client to administrate his unique collaboration community. His collaboration community comprises of 100 partners.

At label 2, he created an invitees list of 80 partners. He began to send invitations to the 80 invitees.

At label 3, since he has not sent any invitations to invitees, no invitees have signed up.

At label 5, the client also had no indecision invitees since no invitations have been sent.

At label 6, the service provider had set a goal of 75 new subscribers to the client in order for him to completely waive his subscription fee.

At label 7, on Jan. 15, 2xxx, twenty-five invitees bought subscriptions.

At label 8, three invitees had declined subscriptions.

At label 9, since fifty-two invitees were indecisive, he began to generate reminders using the client billing system to urge the indecisive invitees to conclude subscriptions.

At label 10, he needed fifty additional subscribers to reduce his subscription fee to zero.

At label 11, the reminder generation process repeated until February 20, where the indecisive invitee number has been reduced to zero. At this point, he no longer needed to generate reminders.

At label 12, he had generated seventy-six new subscribers for the service providers.

At label 13, he has surpassed the goal set forth by the service providers.

Once the clients reach the goal set forth by the service providers, the billing solution will invoke an electronics message to the clients to inform the goal has been reached.

If the client had exceeded the goal set forth by the service providers and then lapsed below the goal, the billing solution will invoke an electronics message to the clients to inform the goal has been lapsed.

At label 14, the client no longer needed to generate additional subscribers since he had reached the goal.

The Client has successfully reduced his subscription fee to zero by using this method.

Referring to FIG. 3, at label 1, this subscription plan, as an example, rewards clients who commit to larger collaboration communities.

At label 3, notice an additional partner cost becomes lower as the community becomes larger.

At label 5, in example 1, the client signed up for a type B subscription plan, which required the client to pay $95 per partner.

At label 9, the client had seventy-five partners.

At label 11, he generated fifty-five new subscribers

At label 12, the client ended up with a subscription fee of $7,125 12.

At label 16, he earned credit of $5,500, equals a net saving in the same amount.

At label 14, his net subscription fee was reduced from $7,125 12 to $1,625.

At label 18, in example 2, the client signed up for a type D subscription plan, which required the client to pay $88 per partner.

At label 25, the client had one hundred thirty-five partners.

At label 27, the client had five partners 27 above the plan limitation.

At label 20, he had to pay for the five extra partner cost, which is $88 each.

At label 22, he ended up with a subscription fee of $11,880.

At label 24, he generated seventy-five new subscribers.

At label 26, he earned credit of $7,500, equals a net saving of the same amount.

At label 27, the client exceeded the subscription plan by 5 partners. Based on the subscription plan he bought, each partner cost is $88.

At label 28, his net subscription fee was reduced from $11,880 22 to $4,380.

At label 32, notice in this example, the external revenue amount is greater than the credit amount.

Referring to FIG. 4, at step 1, client buys a subscription with the service provider for usage of an enterprise solution for document workflow purposes. Typically, the subscription procedures end here.

At step 2, the client can use this method, as an option, to reduce his subscription fee.

At step 3, the client begins by defining all the partners that consists of A-Z, a total of twenty-six companies with whom he wishes to do workflow collaboration, thus defining his collaboration community.

At step 4, the client would create a list within the collaboration community, known as an invitee list, by using the billing solution facilitated by the service provider. The list consists of companies A to T, a total of twenty invitees. Notice that companies T to Z are not among the invitees because the client does not feel that they would buy the subscriptions.

At step 5, the solution would also facilitate mail merge, merging invitees with invitation templates to generate invitations, inviting invitees to buy subscriptions directly with the service provider.

At step 6, the client would use the billing system to monitor the number of indecisive invitees. If he feels that they should be reminded, he will proceed to generating more reminders via the billing system.

The reminder generation process would be repeated until hopefully all the invitees have concluded the subscription decisions.

There are times although the number of inconclusive invitees is still positive, the client may decide not to generate any reminders. Step 10 and step 12 can be executed in parallel.

At step 10, client would generate reminders via the client billing system from time to time to urge the indecisive invitees to quickly conclude the subscription decisions.

At step 12, until subscription fee reaches zero, the client should continue to find ways to increase external revenue. Please be advised that the client does not have to wait until his subscription fee has been reduced to zero before proceeding to step 20. Step 20 and 16 can be executed in parallel.

At step 16, the client would want to earn more credit by further increase external revenue, thus generating more credit to offset the subscription fee.

At step 20, at any time, the client is in a position to calculate how much credit he earned with the external revenue he generated. He can now see how much the subscription fee is reduced by using this method.

At step 22, the client now enters a more mature and routine management phase of managing the cost-sharing program.

Referring to FIG. 5, at step 1, client buys a subscription with the service provider for usage of an enterprise solution for data-exchange collaboration. Typically, the subscription procedures end here.

At step 2, the client can use this method, as an option, to reduce his subscription fee.

At step 3, the client begins by defining all the partners that consists of A-Z, a total of twenty-six companies with whom he wishes to do data-exchange collaboration, thus defining his collaboration community.

At step 4, the client would create a list within the collaboration community, known as an invitee list, by using the billing solution facilitated by the service provider. The list consists of companies A to T, a total of twenty invitees. Notice that companies T to Z are not among the invitees because the client does not feel that they would buy the subscriptions.

At step 5, the solution would also facilitate mail merge, merging invitees with invitation templates to generate invitations, inviting invitees to buy subscriptions directly with the service provider.

At step 6, the client would use the billing system to monitor the number of indecisive invitees. If he feels that they should be reminded, he will proceed to generating more reminders via the billing system.

The reminder generation process would be repeated until hopefully all the invitees have concluded the subscription decisions.

There are times although the number of inconclusive invitees is still positive, the client may decide not to generate any reminders. Step 10 and step 12 can be executed in parallel.

At step 10, client would generate reminders via the client billing system from time to time to urge the indecisive invitees to quickly conclude the subscription decisions.

At step 12, until subscription fee reaches zero, the client should continue to find ways to increase external revenue. Please be advised that the client does not have to wait until his subscription fee has been reduced to zero before proceeding to step 20. Step 20 and 16 can be executed in parallel.

At step 16, the client would want to earn more credit by further increase external revenue, thus generating more credit to offset the subscription fee.

At step 20, at any time, the client is in a position to calculate how much credit he earned with the external revenue he generated. He can now see how much the subscription fee is reduced by using this method.

At step 22, the client now enters a more mature and routine management phase of managing the cost-sharing program.

Referring to FIG. 6, this example illustrates that the collaboration privileges of the client and the partners could, for example, be different.

A client can freely design a flow to collaborate with partners within his collaboration community. One way for a partner to process the same privileges as a client would be to buy the client subscription plan.

At label 1, the client designs a document workflow route as shown by the solid line arrows in diagram.

At label 2, the client is the only collaboration partner for the partners, as shown by the broken and doubled lined arrows

At label 3, a list of partners limited privileges.

At label 4, notice partners in this flow diagram have collaboration privileges restrictions.

Partners can only flow documents freely to the client but no to each other.

At label 6, this particular example involves three partners, two of whom are subscribers and one is not.

In keeping with some aspects according to the present invention, referring to FIG. 7, due to differences in enterprise software architecture, some hosted enterprise solutions may include at least one or more hosted enterprise modules that reside at the users' computers 73 to work in conjunction with the hosted enterprise solution. The hosted enterprise solution can reside in servers 71 managed by the service providers. Users, in one embodiment, acquire hosted enterprise products, hosted enterprise modules to be installed with appropriate hardware 77, 79, or both, in order to work in conjunction with the hosted enterprise solution via the Internet 75. These hosted enterprise products and hosted enterprise modules are things that users of a hosted enterprise solution would use in order to work in conjunction with the hosted enterprise solution. These hosted enterprise products and hosted enterprise modules are things other than standard equipment such as PC's, handhelds, standard computational hardware, etc. Hosted enterprise products or hosted enterprise modules can be acquired from either the service provider and/or any third party or parties. These hosted enterprise products and hosted enterprise modules can be acquired via any structure of monetary payments, such as periodic subscriptions, one-time fees or multiple fees.

Referring to FIG. 3, at label 25 in example 2, there were 75 subscribers 24 with partner subscription fees of $100, which generated credit of $7,500 26. Staying with example 2, if the number of subscribers were different, a different credit amount 26 will be generated, and thus will alter net subscription fee 28. This illustrated that just as long as the number of subscribers 24 are different in any two subscription periods, these two periodic net host subscription fees 28 may vary even if collaboration community usage of the hosted enterprise solution 22, client usage of the hosted enterprise solution 27, all host subscription plans of A to E, all programs 26 that generate values by pre-determined formulas generated by partner subscriptions within the client's collaboration community that can be used to modify the client's host subscription 18, and collaboration community members, are exactly the same during these two subscription periods.

Referring to FIG. 1, in one embodiment, at label 3 the client defines its collaboration community members with whom it collaborates. Since a service provider can serve one or more clients, the service provider can facilitate one or more collaboration communities. A client of a collaboration community can also collaborate with other clients of other collaboration communities but each client will purchase its own host subscription.

In FIG. 8, a system of cost-sharing solution illustrating, as an example, the client earning money from partners' subscription revenue in its collaboration community.

Referring to FIG. 8, at label 1, this subscription plan, as an example, rewards clients who commit to larger collaboration communities.

At label 3, this subscription plan, as an example, rewards clients who commit to more internal users.

At label 9, the client will earn $160 from the service provider for generating a partner subscription within his collaboration community.

At label 11, the client signed up for a host subscription plan that will allow him to have up to 70 partners.

At label 13, the chosen host subscription plan will allow him to have up to 100 internal users.

At label 15, the total host subscription fee for the client is $10,150, consist of up to 70 partners for a cost of $6,650 5 and up to 100 internal users for a cost of $3,500 7.

At label 16, in this subscription period, the client was able to generate 55 partner subscriptions, earning a bonus of $8,800.

At label 18, $8,800 will be remit to the client by the service provider.

At label 20, the client will also remit host subscription fee in the amount of $10,150 to the service provider.

The bonus was not used to modify the client's host subscription fee.

In FIG. 9, an example showing calculation of partner subscription fees in two different subscription periods.

Referring to FIG. 9, at label 1, the client has 100 partners in his collaboration community in the first subscription period.

At label 3, of the 100 partners, 50 of them are subscribers.

At label 5, of the 100 partners, 50 of them are non-subscribers, which means they did not buy a partner subscription.

At label 7, the partner subscription fee during the first subscription period is $10,000.

At label 9, the client has 100 partners in his collaboration community in the second subscription period.

At label 11, of the 100 partners, 20 of them are subscribers.

At label 13, of the 100 partners, 80 of them are non-subscribers, which means they did not buy a partner subscription.

At label 15, the partner subscription fee during the second subscription period is $4,000.

This illustrated that the two periodic partner subscription fees can be different even if the number of partners 19, usage of partners' usage of the hosted enterprise solution, partner subscription fee 19 and the host subscription plan 21 are exactly the same.

What is claimed is:

1. A method of cost-sharing of a host subscription fee, for a client's collaboration community, for using a hosted enterprise solution, the method comprising:
remitting an amount generated by a predetermined function applying to a partner's subscription fee, if any, in the client's collaboration community, to the client;
charging a balance of the client's host subscription fee for the client's collaboration community; and
utilizing a network and communicating the balance of the host subscription fee to the client for payment.

2. The method of claim 1, wherein the method of cost-sharing is offered to a client as an option.

3. The method of claim 1, wherein the client has flexibility to decide which partners within the collaboration community the client defined to invite to become subscribers.

4. The method of claim 3, wherein the flexibility in deciding which partners to invite to become subscribers is a standard and open policy provided by a service provider to the client.

5. The method of claim 1, wherein a partner subscription can be of more than one type.

6. The method of claim 1, wherein the host subscription can be of more than one type.

7. The method of claim 1, wherein the client has flexibility in deciding which partners within the collaboration community the client defined not to invite to become subscribers.

8. The method of claim 7, wherein the flexibility in deciding which partners not to invite to become subscribers is a standard and open policy provided by the service provider to the client.

9. The method of claim 1, wherein the collaboration community's membership changes as a collaboration environment of the client changes.

10. The method of claim 1, wherein each partner can independently alter his subscription status.

11. The method of claim 1, wherein the client's host subscription fee is at least partially contributed by a non-subscriber for using the hosted enterprise solutions.

12. The method of claim 1, wherein the hosted enterprise solution facilitates collaboration privileges to non-subscribers, subscribers and clients.

13. The method of claim 1, wherein there is at least one partner that is a non-subscriber.

14. The method of claim 1, wherein there is at least one partner that is a subscriber.

15. The method of claim 1, wherein the client can create an invitee list related to its collaboration community.

16. The method of claim 17, wherein an invitee list may represent all of the partners from a list of partners within a collaboration community.

17. The method of claim 1, wherein a client can freely remove rights of usage of a hosted enterprise solution of a subscriber in the client's collaboration community.

18. The method of claim 1, wherein a client can freely remove rights of usage of a hosted enterprise solution of a non-subscriber in the client's collaboration community.

19. The method of claim 1, wherein the hosted enterprise solution is accessed by users via the network.

20. The method of claim 1, wherein partner's subscription fee is a monetary fee for hosted enterprise products and hosted enterprise modules required to use the hosted enterprise solution for the partner.

21. The method of claim 1, wherein host subscription fee is a monetary fee for hosted enterprise products and hosted enterprise modules related to using the hosted enterprise solution for the client.

22. The method of claim 1, wherein a client of one collaboration community can collaborate with a client of another collaboration community but each will purchase their own host subscription.

23. The method of claim 1, wherein total partner's subscription fees in any two periods may vary even if the number of partners, partners' usage of the hosted enterprise solution, all subscription plans are exactly the same during these two subscription periods.

24. The method of claim 1, wherein a partner list to define a client's unique collaboration community is created by the client.

25. The method of claim 1, whereas remitting an amount means using the amount to modify the client's hosted subscription fees to which the partners belong.

26. A system for cost-sharing of a host subscription fee, for a client's collaboration community, for using a hosted enterprise solution, the system comprising:
a first module to calculate a client's host subscription fee;
a second module to calculate a value by a pre-determined formula generated by a partner subscription, if any, in the clients' collaboration community, which can be used for remitting to the client; and
a third module to update relevant information that affects subscription fees within the client's collaboration community that is accessible by the client online, utilizing a network.

27. The system of claim 26, wherein the system for cost-sharing is offered to the client as an option.

28. The system of claim 26, wherein the system is configured to calculate the client's host subscription fee including calculating a value by using a pre-determined formula on a partner's subscription within the client's collaboration community to be incorporated into the client's host subscription fee for usage of the hosted enterprise solution.

29. The system of claim 26, wherein the system is configured to provide the client with flexibility to decide which partners within a collaboration community the client defined to invite to become subscribers.

30. The system of claim 26, wherein flexibility in deciding which partners to invite to become subscribers is a standard and open policy provided by a service provider to the client.

31. The system of claim 26, wherein the system is configured to provide the client with flexibility in deciding which partners within a collaboration community the client defined not to invite to become subscribers.

32. The system of claim 26, wherein flexibility in deciding which partners not to invite to become subscribers is a standard and open policy provided by a service provider to the client.

33. The system of claim 26, wherein the system is configured to track entities that decline subscriptions.

34. The system of claim 26, wherein the system is configured to allow the client to manage all subscription activities within the client's collaboration communities.

35. The system of claim 26, wherein the system is configured to receive a subscriber's credit card information.

36. The system of claim 26, wherein the partner subscription can be of more than one type.

37. The system of claim 26, wherein the host subscription fee can be of more than one type.

38. The system of claim 26, wherein the system is configured to allow the client to create an invitee list related to a collaboration community.

39. The system of claim 26, wherein the system is configured to generate invitations to all invitees.

40. The system of claim 26, wherein the system is configured to urge invitees to come to a partner subscription decision.

41. The system of claim 26, wherein the system is configured to track a client's host subscription fee that is at least partially contributed by a partner for using a hosted enterprise solution.

42. The system of claim 26, wherein the system is configured to track a client's host subscription fee that is at least partially contributed by a non-subscriber for using the hosted enterprise solution.

43. The system of claim 26, wherein there is at least one partner that is a non-subscriber.

44. The system of claim 26, wherein there is at least one partner that is a subscriber.

45. The system of claim 26, wherein a subscription fee of the partner and the value are different amounts.

46. The system of claim 26, wherein the system is configured to track a client's host subscription fee that is at least partially contributed by the client for using a hosted enterprise solution.

47. The system of claim 26, wherein a hosted enterprise solution facilitates collaboration privileges for subscribers, non-subscribers and clients.

48. The system of claim 46, wherein privileges to different users under different subscription plans are different.

49. The system of claim 26, wherein a hosted enterprise solution is a data-exchange enterprise collaboration software solution.

50. The system of claim 26, wherein a hosted enterprise solution is a document workflow enterprise collaboration software solution.

51. The system of claim 47, wherein collaboration privileges for subscribers can be different than that of non-subscribers.

52. The system of claim 26, wherein the system is configured so that a client can modify collaboration community memberships that the client defined.

53. The system of claim 26, wherein the system is configured so that a client can freely remove rights of usage of a hosted enterprise solution of a subscriber in its collaboration community.

54. The system of claim 26, wherein the system is configured so that a client can freely remove the rights of usage of a hosted enterprise solution of a non-subscriber in its collaboration community.

55. The system of claim 26, wherein the system is configured so that a partner can independently alter its subscription status.

56. The system of claim 26, wherein the hosted enterprise solution is accessed by users via the network.

57. The system of claim 26, wherein a partner subscription is a monetary fee for hosted enterprise products and hosted enterprise modules related to using the hosted enterprise solution for the partner.

58. The system of claim 26, wherein a host subscription is a monetary fee for hosted enterprise products and hosted enterprise modules related to using the hosted enterprise solution for the client.

59. The system of claim 26, wherein total partner's subscription fees in any two periods may vary even if the number of partners, partners' usage of the hosted enterprise solution, and all subscription plans are exactly the same during these two subscription periods.

60. The system of claim 26, wherein the system is configured so that a client of one collaboration community can collaborate with a client of another collaboration community but each will purchase its own host subscription.

61. The system of claim 26, wherein partners in a client's collaboration community is defined by the client.
